(19) United States
(12) Patent Application Publication
(10) Pub. No.: US 2018/0239557 A1
(43) Pub. Date: Aug. 23, 2018

(54) NONVOLATILE MEMORY DEVICE, DATA STORAGE DEVICE INCLUDING THE SAME, AND OPERATING METHOD OF DATA STORAGE DEVICE

(71) Applicant: SK hynix Inc., Gyeonggi-do (KR)

(72) Inventor: Ji Seon YANG, Gyeonggi-do (KR)

(21) Appl. No.: 15/785,538

(22) Filed: Oct. 17, 2017

(30) Foreign Application Priority Data
Feb. 22, 2017 (KR) 10-2017-0023584

(51) Int. Cl. G06F 3/06; G06F 11/14

(52) U.S. Cl. CPC G06F 3/0659; G06F 11/1471; G06F 2201/82; G06F 3/0679; G06F 2201/805; G06F 3/0604

(57) ABSTRACT

A nonvolatile memory device includes a memory cell region including an external data area and an internal data area; and a control logic suitable for storing history data collected based on control signals received from an external device, in the internal data area, and controlling an operation for the external data area according to the control signals.

### CROSS-REFERENCES TO RELATED APPLICATION

The present application claims priority under 35 U.S.C. § 119(a) to Korean application number 10-2017-0023584, filed on Feb. 22 2017, in the Korean Intellectual Property Office, which is incorporated herein by reference in its entirety.

### BACKGROUND

### 1. Technical Field

Various embodiments generally relate to a data storage device that uses a nonvolatile memory device as a storage medium.

### 2. Related Art

Recently, the paradigm for the computer environment has been converted into ubiquitous computing so that computer systems can be used anytime and anywhere. Due to this, use of portable electronic devices such as mobile phones, digital cameras, and notebook computers has rapidly increased. In general, such portable electronic devices use a data storage device which uses one or more memory devices for storing data. The data storage device may be used as an auxiliary memory device of a portable electronic device.

A data storage device using a memory device provides advantages in that, since it has no mechanical driving part, stability and durability are excellent an information access speed is high and power consumption is small. Examples of data storage devices having such advantages include a universal serial bus (USB) memory device, memory cards having various interfaces, and a solid state drive (SSD).

As portable electronic devices play and store large files such as music or video files, the data storage device is required to have a large storage capacity, Data storage devices use as storage media, one or more memory device having a high integration degree for memory cells for securing a large storage capacity. A flash memory device is an example of a high capacity nonvolatile memory device.

### SUMMARY

Various embodiments are directed to a nonvolatile memory device capable of storing history data on a performed operation, a data storage device including the same, and an operating method of the data storage device.

In an embodiment, a nonvolatile memory device may include: a memory cell region including an external data area and an internal data area; and a control logic suitable for storing history data collected based on control signals received from an external device, in the internal data area, and controlling an operation for the external data area according to the control signals.

In an embodiment, a data storage device may include: a controller suitable for providing control signals; and a nonvolatile memory device suitable for performing a controller-dependent operation for an external data area according to the control signals, and performing a controller-independent operation of storing an information on the controller-dependent operation in an internal data area.

In an embodiment, a method for operating a data storage device including a nonvolatile memory device and a controller which controls the nonvolatile memory device may include: providing a command and an address for controlling the nonvolatile memory device; storing the command and the address in an internal data area of the nonvolatile memory device, as history data; and performing an operation for an external data area of the nonvolatile memory device, according to the command and the address.

According to the embodiments because history data on a performed operation may be provided from a nonvolatile memory device, the management operation of the controller for the nonvolatile memory device may be efficiently performed.

### BRIEF DESCRIPTION OF THE DRAWINGS

FIG. 1 is a block diagram illustrating a nonvolatile memory device in accordance with an embodiment of the present invention.

FIG. 2 is a diagram illustrating an exemplary configuration of the memory cell region shown in FIG. 1 in accordance with the embodiment of the present invention.

FIG. 3 is a diagram illustrating history data stored in a history data area in accordance with the embodiment of the present invention.

FIGS. 4A and 4B are diagrams illustrating control signals and data provided to a nonvolatile memory device in accordance with the embodiment of the present invention.

FIG. 5 is a flow chart illustrating an exemplary operation of a nonvolatile memory device in accordance with the embodiment of the present invention.

FIG. 6 is a block diagram illustrating a data storage device including a nonvolatile memory device in accordance with an embodiment of the present invention.

FIG. 7 is a flow chart illustrating an operation of a data storage device in accordance with an embodiment of the present invention.

FIG. 8 is a diagram illustrating a data processing system including a solid state drive in accordance with an embodiment of the present invention.

FIG. 9 is a diagram illustrating a data processing system including a data storage device in accordance with an embodiment of the present invention.

FIG. 10 is a diagram illustrating a data processing system including a data storage device in accordance with an embodiment of the present invention.

FIG. 11 is a diagram illustrating a network system including a data storage device in accordance with an embodiment of the present invention.

### DETAILED DESCRIPTION

In the present invention, advantages, features and methods for achieving them will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features steps operations, and/or elements thereof.

It is further noted that in the following description, specific details are set forth for facilitating the understanding of the present invention, however the present invention may be practiced without some or all of these specific details. Also, it is noted, that well-known structures and/or processes may have only been described briefly or not described at all to avoid obscuring the present disclosure with unnecessary well known details.

It is also noted, that in some instances, as would be apparent to those skilled in the relevant art, an element (also referred to as a feature) described in connection with one embodiment may be used singly or in combination with other elements of another embodiment, unless specifically indicated otherwise.

Hereinafter, a nonvolatile memory device, a data storage device including the same, and an operating method of the data storage device will be described below with reference to the accompanying drawings through various examples of embodiments.

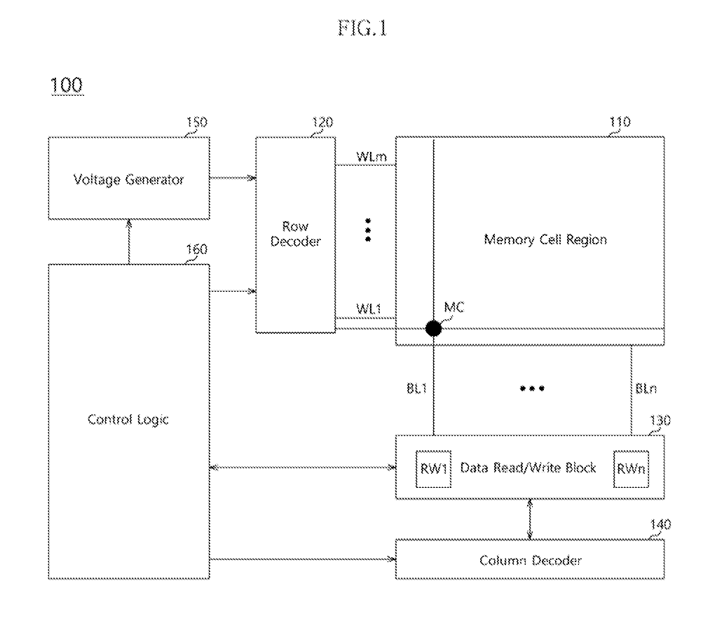

FIG. 1 is a block diagram illustrating a nonvolatile memory device 100 in accordance with an embodiment of the present invention.

The nonvolatile memory device 100 may be configured by any one of various types of nonvolatile memory devices such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase change random access memory (PCRAM) using a chalcogenide alloy, and a resistive random access memory (RERAM) using a transition metal oxide.

Referring to FIG. 1, the nonvolatile memory device 100 may include a memory cell region 110, a row decoder 120, a data read/write block 130, a column decoder 140, a voltage generator 150, and a control logic 160.

The memory cell region 110 may include a plurality of memory cells which are arranged at areas where a plurality of word lines WL1 to WLm and a plurality of bit lines BL1 to BLn intersect with each other, The memory cells may configure memory blocks and pages. Memory blocks and pages will be described below in detail.

The row decoder 120 may be coupled with the memory cell region 110 through the word lines WL1 to WLm. The row decoder 120 may operate according to control of the control logic 160. The row decoder 120 may decode an address provided from an external device (not shown). The row decoder 120 may select and drive the word lines WL1 to WLm, based on a decoding result. For instance, the row decoder 120 may provide a word line voltage provided from the voltage generator 150, to one or more selected word lines WL1 to WLm.

The data read/write block 130 may be coupled with the memory cell region 110 through the bit lines BL1 to BLn. The data read/write block 130 may include read/write circuits RW1 to RWn respectively corresponding to the bit lines BL1 to BLn. The data read/write block 130 may operate according to control of the control logic 160. The data read/write block 130 may operate as a write driver or a sense amplifier depending on an operation mode. For example, the data read/write block 130 may operate, in a write operation, as a write driver which stores data provided from the external device, in the memory cell region 110. For another example, the data read/write block 130 may operate in a read operation, as a sense amplifier which reads out data from the memory cell region 110.

The column decoder 140 may operate according to control of the control logic 150. The column decoder 140 may decode an address provided from the external device. The column decoder 140 may couple the read/write circuits RW1 to RWn of the data read/write block 130 with data input/output buffers (not shown) based on a decoding result.

The voltage generator 150 may generate voltages to be used in internal operations of the nonvolatile memory device 100. The voltages generated by the voltage generator 150 may be applied to the memory cells of the memory cell region 110. For example, a program voltage generated in a program operation may be applied to a word line of memory cells for which the program operation is to be performed, through the row decoder 120. For another example, read voltage generated in a read operation may be applied to a word line of memory cells for which the read operation is to be performed, through the row decoder 120. For still another example, an erase voltage generated in an erase operation may be applied to a well area of memory cells for which the erase operation is to be performed.

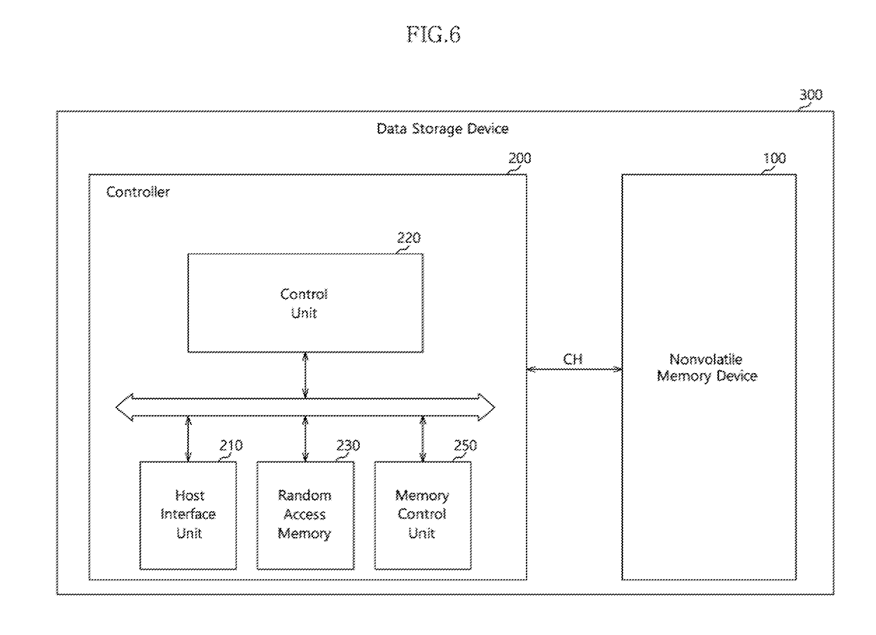

The control logic 160 may control general operations of the nonvolatile memory device 100 according to control signals (for example, commands, addresses and so on) provided from the external device, for example, a controller 200 of FIG. 6. For example, the control logic 160 may control the internal function blocks or circuits 120, 130, 140 and 150 to perform read, write (or program) and erase operations according to control signals. An operation of the nonvolatile memory device 100 which is performed according to the control signals provided from the controller will be defined as a controller-dependent operation.

The control logic 160 may store history data before performing the operation according to the control signals. That is, the control logic 160 may store history data to record which operation has been performed according to control of the external device. The control logic 160 may store automatically history data even though the controller does not perform a separate control task to store history data. An operation which is performed by the nonvolatile memory device 100 itself even though control signals are not provided from the controller will be defined as a controller independent operation.

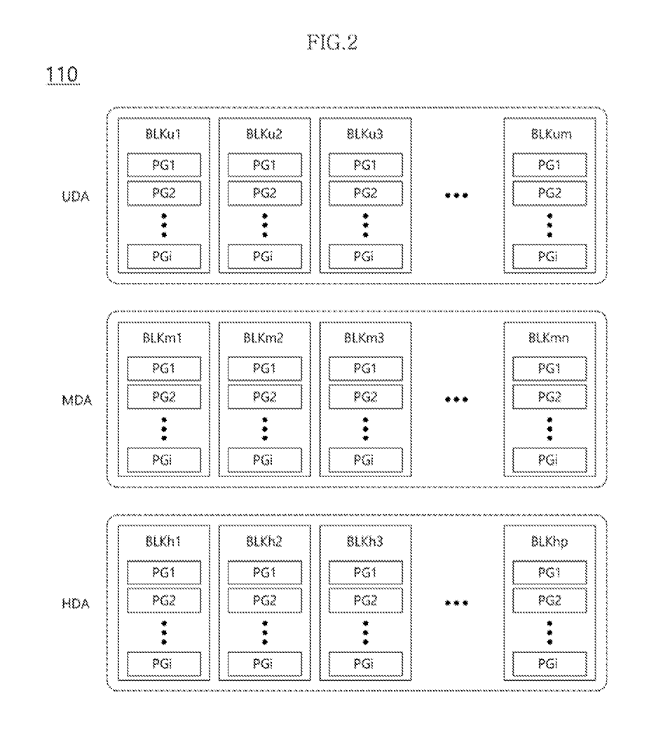

FIG. 2 is a diagram illustrating an exemplary configuration of the memory cell region 110 shown in FIG. 1 in accordance with the embodiment of the present invention.

As described above, from an operational viewpoint or a physical (or structural) viewpoint, the memory cells of the memory cell region 110 may be configured into hierarchical memory cell sets or memory cell units such as a memory block BLK and/or a page PG. For example, memory cells which are coupled to the same word line and are to be read and written (or programmed) simultaneously may be configured as a page PG. Also, memory cells which are to be erased simultaneously may be configured as a memory block BLK. The number of memory blocks BLK which configure the memory cell region 110 and the number of pages PG which are included in each memory block BLK may be changed variously.

The memory cell region 110 may include a user data area UDA, a metadata area MDA and a history data area HDA which may be divided depending on a use or the kind of data to be stored.

The user data area UDA may include a plurality of memory blocks BLKu1 to BLKum. The user data area UDA may be used for storing user data. The user data may be data generated and used in a software layer of a host device which is controlled by a user, such as application program codes and files.

The metadata area MDA may include a plurality of memory blocks BLKm1 to BLKmn. The metadata area MDA may be used in storing metadata. The metadata may be data generated and used in the controller (e.g., 200 of FIG. 6) which directly controls the nonvolatile memory device 100, such as firmware codes, address mapping data and data for managing user data.

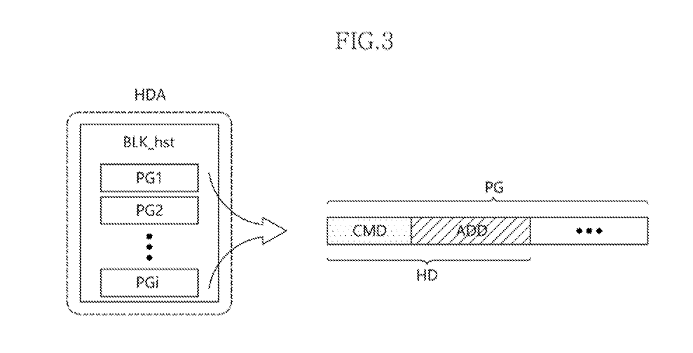

The history data area HDA, may include a plurality of memory blocks BLKh1 to BLKhp. The history data area HDA may be used in storing history data. The history data may be data collected in the nonvolatile memory device 100. The history data will be described below in detail with reference to FIG. 3.

Although the user data is the data generated in the software layer of the host device, the user data may be provided from the controller 200 of FIG. 6 according to a request from the host device. The metadata may be provided from the controller 200 because the metadata is the data generated in the controller 200. Thus, the user data area UDA and the metadata area MDA which respectively store the user data and the metadata provided from an exterior of the nonvolatile memory device 100 will be defined as an external data area.

Because the stored history data may be the data collected in the nonvolatile memory device 100, the history data may not be provided from the controller 200. Thus, the history data area HDA which stores the history data will be defined as an internal data area.

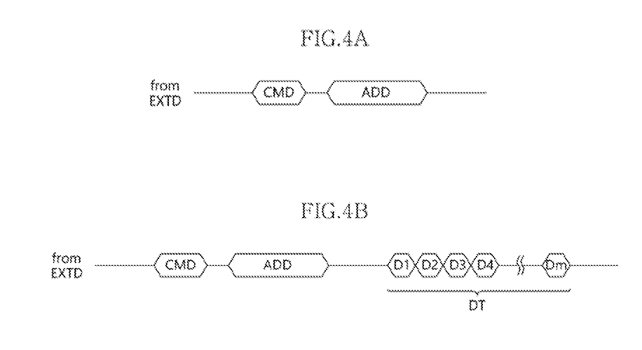

FIG. 3 is a diagram illustrating history data HD stored in the history data area HDA in accordance with the embodiment of the present invention. FIGS. 4A and 4B are exemplary diagrams illustrating control signals provided to a nonvolatile memory device in accordance with the embodiment of the present invention.

Referring to FIG. 3, for the sake of convenience in explanation, one history memory block BLK_hst included in the history data area HDA is illustrated exemplarily. History data HD may be stored in pages PG1 to PGi of the history memory block BLK_hst. One or more history data HD may be stored in one page. The number of history data HD to be stored in one page may be changed depending on a design intention.

The control logic 160 of FIG. 1 may collect history data HD based on control signals provided from the external device, and store the collected history data HD in the pages PG1 to PGi of the history memory block BLK_hst. The control logic 160 may collect and store sequentially history data HD each time control signals are provided from the external device.

Referring to FIG. 4A, if a command CMD instructing a read or erase operation and an address ADD where the read or erase operation is to be performed are provided from an external device EXTD, the control logic 160 may collect and store the command CMD and the address ADD as history data HD. Referring to FIG. 4B, if a command CMD instructing a write operation, an address ADD indicating memory region or location for the write operation to be performed and data DT including D1 to Dm are provided from an external device EXTD, the control logic 160 may collect and store only the command CMD and the address ADD as history data HD.

Because the command CMD and the address ADD provided from the external device EXTD are included in the history data HD, the history data HD may include information on a controller-dependent operation. That is, the history data HD may include information on an operation to be performed by the nonvolatile memory device 100 according to control signals and an address indicating a memory region or location for the operation to be performed.

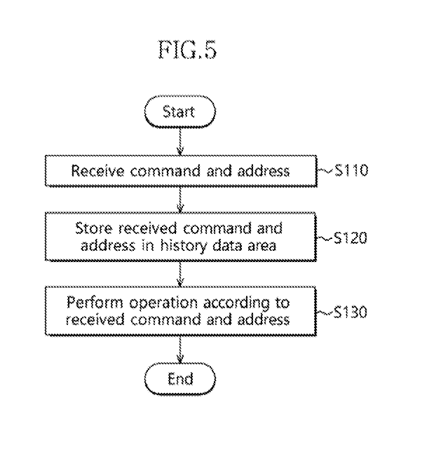

FIG. 5 is a flow chart illustrating an exemplary operation of the nonvolatile memory device 100 of FIG. 1 in accordance with the embodiment of the present invention.

At step S110, the nonvolatile memory device 100 may receive a command and an address from the external device, for example, the controller 200 of FIG. 6.

At step S120, the nonvolatile memory device 100 may store the received command and address in the history data area HDA. In other words, the nonvolatile memory device 100 may perform a controller-independent operation of storing the history data.

At step S130, the nonvolatile memory device 100 may perform an operation according to the received command and address. Namely, the nonvolatile memory device 100 may perform a controller-dependent operation including a read, write or erase operation for the external date area according to the received command and address.

FIG. 6 is a block diagram illustrating a data storage device 300 including a nonvolatile memory device 100 in accordance with an embodiment of the present invention, The data storage device 300 may store data to be accessed by a host device (not shown) such as a mobile phone, an MP3 player, a laptop computer, a desktop computer, a game player, a television (TV), an in-vehicle infotainment system, and so forth. The data storage device 300 may also be referred to as a memory system.

The data storage device 300 may be manufactured as any one of various kinds of storage devices depending on a standard transmission protocol that is coupled with the host device, For example, the data storage device 300 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-e or PCIe) card type storage device, a compact flash (CF) card, a smart media card, a memory stick, and so forth.

The data storage device 300 may be manufactured as any one among various kinds of package types. For example, the data storage device 300 may be manufactured as any one of various kinds of package types such as a package-on-package (POP), a system-in-package (SIP), a system-on-chip (SOC), a multi-chip package (MCP), a chip-on-board (COB), a wafer-level fabricated package (WP) and a wafer-level stack package (WSP),

The data storage device 300 may include the nonvolatile memory device. The nonvolatile memory device 100 may be configured by the nonvolatile memory device 100 shown in FIG. 1. The nonvolatile memory device 100 may be coupled with a controller 200 through a channel CH which means a signal line (or signal lines) capable of transmitting and/or receiving a command, an address, control signals and data. The nonvolatile memory device 100 may be used as the storage medium of the data storage device 300.

The data storage device 300 may include the controller 200. The controller 200 may directly control the nonvolatile memory device 100 according to a request from the host device. For example, the controller 200 may store the data provided from the host device, in the nonvolatile memory device 100, according to a write request from the host device. For another example, the controller 200 may provide the data read out from the nonvolatile memory device 100, to the host device, according to a read request from the host device.

The controller 200 may include a host interface unit 210, control unit 220, a random access memory 230, and a memory control unit 250.

The host interface unit 210 may interface between the host device and the data storage device 300. For example, the host: interface unit 210 may communicate with the host device by using any suitable transmission protocol such as, for example, a universal serial bus (USB), a universal flash storage (UFS), a multimedia card (MMC), a parallel advanced technology attachment (DATA), a serial advanced technology attachment (SATA), a small computer system interface (SCSI), a serial attached SCSI (SAS), a peripheral component interconnection (PCI) and PCI express (PCI-E) protocols.

The control unit 220 may control general operations of the controller 200. The control unit 220 may drive an instruction or an algorithm of a code type, that is, a software, loaded in the random access memory 230, and may control operations of function blocks in the controller 200. The control unit 220 may be configured by a micro control unit (MCU) or a central processing unit (CPU).

The random access memory 230 may store a software to be driven by the control unit 220. Further, the random access memory 230 may store metadata necessary for driving of the software. The random access memory 230 may be configured, for example, by a dynamic random access memory (DRAM) or a static random access memory (SRAM).

The memory control unit 250 may control the nonvolatile memory device 100 according to control of the control unit 220. The memory control unit 250 may also be referred to as a memory interface unit. The memory control unit 250 may provide control signals to the nonvolatile memory device 100. The control signals may include a command, an address a control signal and so forth for controlling the nonvolatile memory device 100. The memory control unit 250 may provide data to the nonvolatile memory device 100 or may be provided with the data read out from the nonvolatile memory device 100.

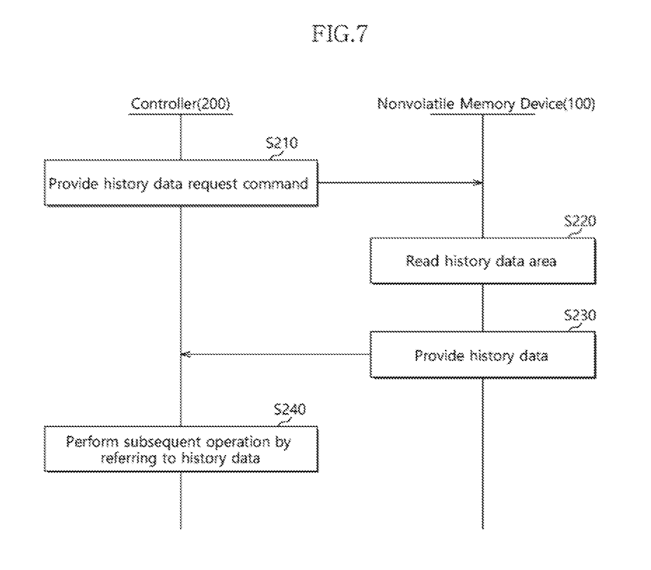

FIG. 7 is a flow chart illustrating an operation of a data storage device in accordance with an embodiment of the present invention. The operation of the nonvolatile memory device 100 responding to a request from the controller 200 will be described with reference to FIG. 7.

At step S210, the controller 200 may provide a history data request command to the nonvolatile memory device 100. The history data request command may be a special command for reading out the history data stored in the history data area HDA of a memory cell region included in the nonvolatile memory device 100, that is, information on a controller-dependent operation.

At step S220, the nonvolatile memory device 100 may read the history data area HDA according to the history data request command. For example, the nonvolatile memory device 100 may read only the history data area HDA where history data HD is stored last. For another example the nonvolatile memory device 100 may read the entire history data area HDA.

At step S230, the nonvolatile memory device 100 may provide the read history data HD to the controller 200. For example, in the case where only the history data area HDA where history data HD is stored last is read, the nonvolatile memory device 100 may provide the last-stored history data HD to the controller 200. For another example, in the case where the entire history data area HDA is read, the nonvolatile memory device 100 may provide all the read history data HD to the controller 200.

At step S240, the controller 200 may perform a subsequent operation by referring to the provided history data HD.

For example, in the case where recovery is made from a sudden power-off state to a normal state, the controller 200 may perform an error handling operation for an operation performed last by the nonvolatile memory device 100, by referring to the history data HD. The error handling operation may include an operation of controlling the nonvolatile memory device 100 such that an operation not completed by the nonvolatile memory device 100 due to the sudden power-off state, that is, an operation performed last, is performed again.

For another example, in the case where the nonvolatile memory device 100 is in a malfunction state, the controller 200 may perform a debugging operation for an operation performed last by the nonvolatile memory device 100 by referring to the history data HD.

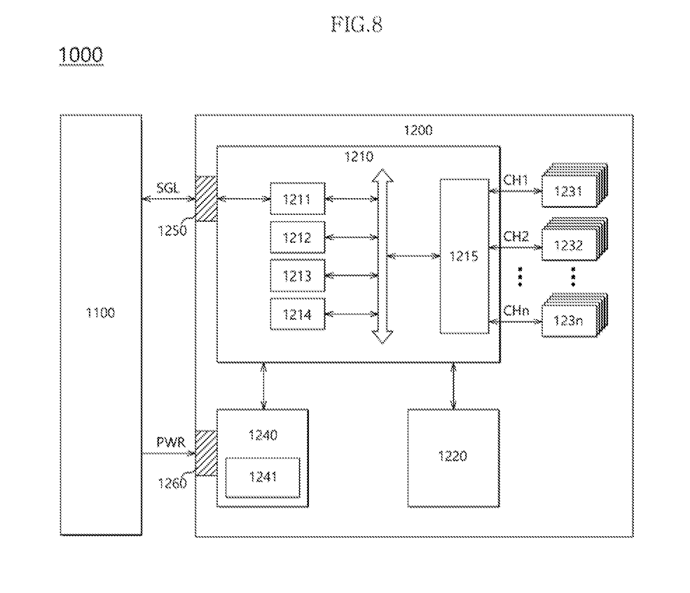

FIG. 8 is a diagram illustrating a data processing system 1000 including a solid state drive (SSD) 1200 in accordance with an embodiment of the present invention. Referring to FIG. 8, the data processing, system 1000 may include a host device 1100 and the SSD 1200.

The SSD 1200 may include a controller 1210, buffer memory device 1220, nonvolatile memory devices 1231 to 123n, a power supply 1240, a signal connector 1250, and a power connector 1260.

The controller 1210 may control general operations of the SSD 1200. The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface between the host device 1100 and the SSD 1200 according to the protocol of the host device 1100. For example, the host interface unit 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-e or PCIe) and universal flash storage (UFS).

The control unit 1212 may analyze and process the signal SGL received from the host device 1100. The control unit 1212 may control operations of internal function blocks according to a firmware or a software for driving the SSD 1200. The random access memory 1213 may be used as a working memory for driving such a firmware or software.

The ECC unit 1214 may generate parity data for data to be transmitted to the nonvolatile memory devices 1231 to 123n. The generated parity data may be stored together with the data in the nonvolatile memory devices 1231 to 123n. The ECC unit 1214 may detect an error of the data read out from the nonvolatile memory devices 1231 to 123n, based on the parity data. If a detected error is within a correctable range, the ECC unit 1214 may correct the detected error.

The memory interface unit 1215 may provide control signals such as commands and addresses to the nonvolatile memory devices 1231 to 123n, according to control of the control unit 1212. Moreover, the memory interface unit 1215 may exchange data with the nonvolatile memory devices 1231 to 123n, according to control of the control unit 1212. For example, the memory interface unit 1215 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to control of the controller 1210.

The nonvolatile memory devices 1231 to 123n may be used as storage media of the SSD 1200, The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR provided through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may, for example, include one or more capacitors with large capacity.

The signal connector 1250 may be configured by various types of connectors depending on an interface scheme between the host device 1100 and the SSD 1200.

The power connector 1260 may be configured by various types of connectors depending on a power supply scheme of the host device 1100.

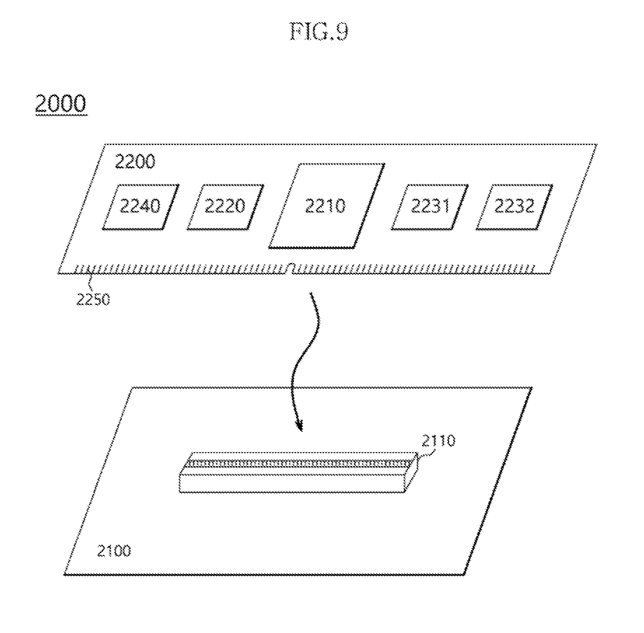

FIG. 9 is a diagram illustrating a data processing system 2000 including a data storage device 2200 in accordance with an embodiment of the present invention. Referring to FIG. 9 the data processing system 2000 may include a host device 2100 coupled to the data storage device 2200.

The host device 2100 may be configured in the form of a board such as a printed circuit board (PCB). Although not shown, the host device 2100 may include internal function blocks for performing various functions as a host device.

The host device 2100 may include a connection terminal 2110 such as a socket, a slot or a connector, The data storage device 2200 may be mounted to the connection terminal 2110.

The data storage device 2200 may be configured in the form of a board such as a printed circuit board (PCB). The data storage device 2200 may be referred to as a memory module or a memory card. The data storage device 2200 may include a controller 2210, a buffer memory device 2220, nonvolatile memory devices 2231 and 2232, a power management integrated circuit (PMIC) 2240, and a connection terminal 2250.

The controller 2210 may control general operations of the data storage device 2200, The controller 2210 may be configured in the s me manner as the controller 1210 shown in FIG. 8.

The buffer memory device 2220 may temporarily store data to be stored in the nonvolatile memory devices 2231 and 2232. Further, the buffer memory device 2220 may temporarily store the data read out from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the data storage device 2200.

The PMIC 2240 may provide the power provided through the connection terminal 2250, to the inside of the data storage device 2200. The PMIC 2240 may manage the power of the data storage device 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the data storage device 2200. The connection terminal 2250 may be configured into various types depending on an interface scheme between the host device 2100 and the data storage device 2200. The connection terminal 2250 may be disposed on any one side of the data storage device 2200.

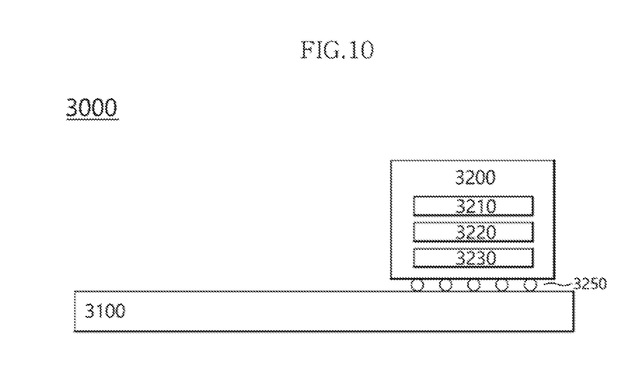

FIG. 10 is a diagram illustrating a data processing system 3000 including a data storage device 3200 in accordance with an embodiment of the present invention. Referring to FIG. 10, the data processing system 3000 may include a host device 3100 and the data storage device 3200.

The host device 3100 a be configured in the form of a board such as a printed circuit board (PCB). Although not shown, the host device 3100 may include internal function blocks for performing various functions as a host device.

The data storage device 3200 may be configured in the form of a surface-mounting type package, The data storage device 3200 may be mounted to the host device 3100 through one or more solder balls 3250. The data storage device 3200 may include a controller 3210, a buffer memory device 3220, and a nonvolatile memory device 3230.

The controller 3210 may control general operations of the data storage device 3200. The controller 3210 may be configured in the same manner as the controller 1210 shown in FIG. 8.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the data storage device 3200.

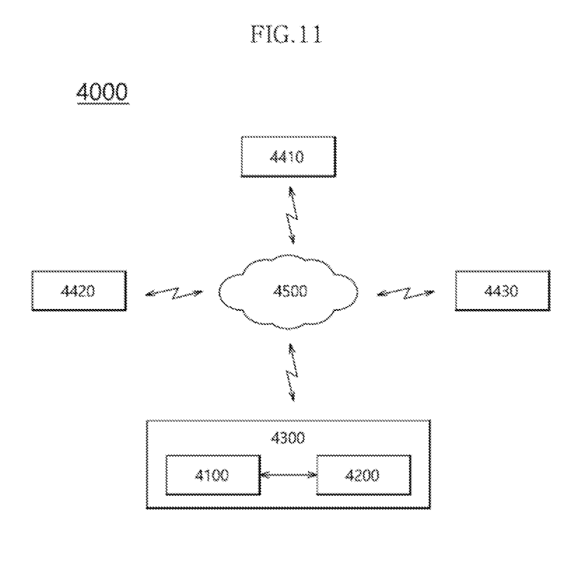

FIG. 11 is a diagram illustrating a network system 4000 including a data storage device 4200 in accordance with an embodiment of the present invention. Referring to FIG. 11, the network system 4000 may include a server system 4300 and a plurality of client systems 4410 to 4430 which are coupled through a network 4500.

The server system 4300 may serve data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the data storage device 4200. The data storage device 4200 may be configured by the data storage device 300 shown in FIG. 6, the data storage device 1200 shown in FIG. 8, the data storage device 2200 shown in FIG. 9 or the data storage device 3200 shown in FIG. 10.

While various embodiments have been described above, it will be understood to those skilled in the art that the embodiments described are examples only. Accordingly, the nonvolatile memory device, the data storage device including the same and the operating method of the data storage device described herein should not be limited based on the described embodiments, and many other embodiments or variations thereof may be envisaged by those skilled in the art to which the present invention belongs without departing from the scope or spirit of the present invention.

What is claimed is:

1. A nonvolatile memory device comprising:
a memory cell region including an external data area and an internal data area; and
a control logic suitable for storing history data collected based on control signals received from an external device, in the internal data area, and controlling an operation for the external data area according to the control signals.

2. The nonvolatile memory device according to claim 1, wherein the history data includes a command and an address collected based on the control signals.

3. The nonvolatile memory device according to claim 1, wherein the control logic stores the history data collected based on the received control signals in the internal data area before performing an operation for the external data area corresponding to the history data.

4. The nonvolatile memory device according to claim 1, wherein the control logic provides the history data stored in the internal data area, to the external device, in response to a history data request command received from the external device.

5. The nonvolatile memory device according to claim 1, wherein the external data area comprises a user data area which stores user data and a metadata area which stores metadata.

6. The nonvolatile memory device according to claim 1, wherein the operation for the external data area includes at least one of read, write and erase operations.

7. A data storage device comprising:
a controller suitable for providing control signals; and
a nonvolatile memory device suitable for performing a controller-dependent operation for an external data area according to the control signals, and performing a controller-independent operation of storing information on the controller-dependent operation in an internal data area.

8. The data storage device according to claim 7, wherein the information on the controller-dependent operation includes a command and an address collected based on the control signal.

9. The data storage device according to claim 7, wherein the nonvolatile memory device performs the controller-independent operation earlier than the controller-dependent operation.

10. The data storage device according to claim 7, wherein the controller provides an information request command which requests the information on the controller-dependent operation, to the nonvolatile memory device.

11. The data storage device according to claim 10, wherein the nonvolatile memory device provides the information on the controller-dependent operation to the controller in response to the information request command.

12. The data storage device according to claim 11, wherein the controller performs an error handling operation for an operation performed last by the nonvolatile memory device, by referring to lastly stored information on the controller-dependent operation.

13. The data storage device according to claim 7, wherein the controller-dependent operation includes at least one of read, write and erase operations.

14. A method for operating a data storage device including a nonvolatile memory device and a controller which controls the nonvolatile memory device, the method comprising:
providing, by the controller, a command and an address for controlling the nonvolatile memory device;
storing, by the nonvolatile memory device, the command and the address in an internal data area of the nonvolatile memory device, as history data; and
performing, by the nonvolatile memory device, an operation for an external data area of the nonvolatile memory device, according to the command and the address.

15. The method according to claim 14, wherein the operation for the external data area is performed after storing the history data in the internal data area.

16. The method according to claim 14, further comprising:
providing, by the controller, a command which requests transmission of the history data.

17. The method according to claim 16, further comprising:
providing, by the nonvolatile memory device, the history data to the controller according to the command which requests transmission of the history data.

18. The method according to claim 17, wherein an error handling operation is additionally performed for an operation performed last by the nonvolatile memory device, by referring to the history data.

19. The method according td claim 14, wherein the operation for the external data area includes at least rune of read, write and erase operations.

20. A nonvolatile memory device comprising:
a memory cell region including an external data area and an internal data area;
an internal function circuit configured to perform operations for the external data area and
a control logic configured to:
receive control signals provided from an external device;
store an operation control signal including command and address in the internal data area as a history data; and
control the internal function circuit to perform an operation for the external data area corresponding the history data.
